(19) United States
(12) Patent Application Publication
(10) Pub. No.: US 2009/0304021 A1
(43) Pub. Date: Dec. 10, 2009

(54) Method and System For Dynamic Resource Allocation

(76) Inventors: Lars Kraemer, Hannover (DE); Arne Zender, Bad Salzdetfurth (DE); Vasco Vollmer, Bad Salzdetfurth (DE); Alexander Weber, Hildesheim (DE); Michael Busse, Hannover (DE)

Correspondence Address: KENYON & KENYON LLP, ONE BROADWAY, NEW YORK, NY, 10004, US

(21) Appl. No.: 12/087,802

(22) PCT Filed: Jan. 3, 2007
(86) PCT No.: PCT/EP2007/050032

§ 371 Date: Nov. 24, 2008

(30) Foreign Application Priority Data
Jan. 20, 2006 (DE) 10 2006 003 067.2

(51) Int. Cl. H04L 12/43; H04J 3/22

(52) U.S. Cl. 370/458; 370/468

(57) ABSTRACT

In a method for the dynamic assignment of resources in a communication system, a cyclical time frame of at least intermittently fixed temporal duration is predefined for the access of communication participants, time slots in the time frame being assigned to the communication participants. The duration of unused time slots is shortened, which means that additional time slots are able to be accommodated in the time frame, which are assigned to communication participants dynamically, in particular as a function of their communication requirements.

### BACKGROUND OF THE INVENTION

1. Field of the Invention

The present invention relates to a method and a system for dynamic assignment of resources in a communication system.

2. Description of Related Art

In motor vehicles, serial bus systems are provided to enable data exchange between communication participants in the form of electronic components. The unit comprising the transmission medium and the bus controllers connected to it is called a bus system. Control units (electronic control units, abbreviated: ECUs) are connected to bus systems via bus controllers and thus are able to bring data to the bus and intercept data from the bus.

To be able to transmit data, the bus controllers must obtain exclusive access to the transmission medium. Only one single bus controller is able to bring data to the bus at one time. All other connected bus controllers must wait to transmit until the current transmission is completed.

To coordinate the bus controllers' access to media, bus systems usually implement different media access methods (media access control, abbreviated: MAC). The standardized bus system FlexRay uses, for example, a media access method that establishes a fixed, cyclical time pattern on the transmission medium and permanently assigns individual time slices to individual communication participants. They may use the cyclically-recurring time slices that are assigned to them to send their messages or they may leave the assigned time slices unused. The CAN bus system, which is likewise standardized, uses a media access method that assigns permanently defined priorities to individual message types. In competition situations, in each instance the communication participant whose message has the highest priority of all competing messages obtains the right to transmit.

A bus system is a special case of a communication system. In general, these are devices for supporting the transmission of information.

Technically it is possible—and in telecommunications systems it is also already customary—to determine and to influence online, that is, during system run time, the quality of the information transmission (quality of service, abbreviated: QOS) with the aid of the measurement of suitable parameters. Such parameters describe, for example, the time response (transmission times, delay times, etc.) and the performance (bandwidth, throughput, etc.) of a connection.

However, the communication systems installed in motor vehicles today do not permit control or permit only insufficient control over the QOS. Corresponding devices for monitoring and influencing the QOS are lacking.

In order to nevertheless achieve a defined connection quality, the resources in motor-vehicle communication systems are statically assigned to the communication participants. For this reason, at the time of integration all connections that have ever existed between communication participants and also their exact resource requirements are necessarily known.

Resources that are not utilized by communication participants during the runtime of the communication system are normally not otherwise used and remain unused.

An assignment of transmission resources in a message transmission system is known from published European patent document EP 1 061 671. In it, a communication participant informs a main station that it would like only a reduced transmission resource capacity. The unused capacity is then assigned to other communication participants.

### BRIEF SUMMARY OF THE INVENTION

According to the present invention, that is, a cyclical time frame of at least intermittently fixed temporal duration is predefined for the access by communication participants, time slots in the time frame are assigned to the communication participants, the duration of unused time slots is shortened, which means that additional time slots are able to be accommodated in the time frame, the time slots are allocated to the communication participants dynamically, in particular as a function of their communication requirements, increase the flexibility of the resource utilization.

At runtime, resources that remain spontaneously unused are able to be assigned to other connections and thus the usage intensity of the communication system is able to be increased. Likewise, connections are able to be necessarily restricted with regard to their resource consumption. Furthermore, when implementing the method according to the present invention, it remains possible to integrate into the communication system communication participants that do not implement the method described here.

Unlike in published European patent document EP 1 061 671, the central instance is not dependent on receiving information from a communication participant about a reduced resource requirement. It decides itself when and to whom it assigns additional time slots.

It is particularly advantageous to use a central instance, in particular a resource manager, to allocate the time slots and the additional time slots. This simplifies the communication effort, prevents possible collisions, and optimizes the utilization of transmission resources.

Through the exchange of quality parameters, which in particular are managed and evaluated by the central instance, the allocation of resources and the allocation of time slots is able to be adjusted to the different communication requirements.

The allocation of time slots within the time frame may take place as a function of the priority. Thus, it is guaranteed that high-priority communication requirements are taken into account in every case.

The time slot allocations are advantageously transmitted to the communication participants via control messages. A re-assignment takes place only after a subsequent control message. This reduces the control and data-exchange overhead. When communication connections are divided into classes, a separate quality parameter set may be assigned to each class. This way, a separate parameter set does not have to be evaluated for each connection. This facilitates the evaluation and calculation in the central instance.

The time slots are advantageously designed to be identifiable. Consequently, the assignment to communication participants is unique and exclusive.

The method according to the present invention is able to be advantageously integrated in a FlexRay bus system, in which existing architectures and arrangements are able to continue existing without modification.

### BRIEF DESCRIPTION OF THE SEVERAL VIEWS OF THE DRAWING

FIG. 1 shows a FlexRay network.

FIG. 2 shows a time frame structure for the communication.

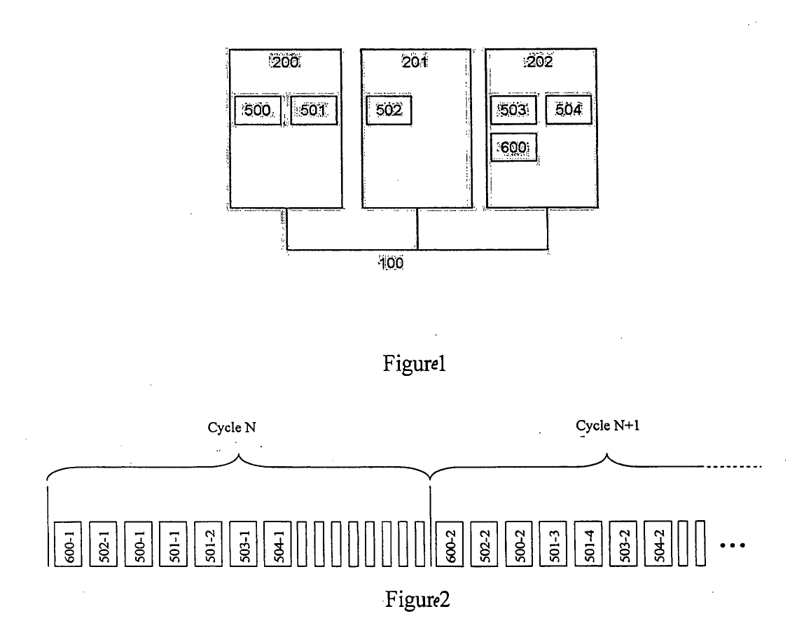

### DETAILED DESCRIPTION OF THE INVENTION

A communication system that is able to be used for the present invention has the following qualities:
The communication system establishes a communication cycle having an at least intermittently fixed temporal duration.
The established cycle is subdivided into any number of time slots.
The time slots are identifiable, that is, they have unique identifiers. Ideally this is a serial numbering.
Communication participants obtain exclusive transmission authorizations for a predefined number of time slots.
Unused time slots are advantageously automatically shortened with regard to their temporal duration, which means that a communication cycle may include a variable number of time slots, because it has a fixed temporal duration.

In place of an automatic shortening of the unused time slots, in particular through network-typical characteristic quantities, a shortening may also alternatively be carried out by a central instance.

An example of a communication system that has the listed qualities is the FlexRay bus system (FlexRay Communication System Protocol Specification, FlexRay Consortium, June 2004).

Communication participants in the form of the ECUs explained at the beginning, on which one or more software applications is/are executed respectively, are connected to this communication system. Furthermore, it is assumed that these software applications occasionally contact other software applications that are connected to the system, in order to exchange data with them. Such connections may be sporadic, that is, not existing throughout the entire runtime of the system, or permanent.

According to this invention, a central instance now exists in the communication system, hereinafter called resource manager, that occasionally grants transmission authorizations for messages to the software applications of the communication participants and thus manages communication system resources.

Due to the explained properties of the communication system, the allocation of communication system resources to software applications takes place through the exclusive allocation of time slots. The software applications may use the time slots allocated to them for the transmission of one message each, or also leave time slots unused.

To provide the software applications of the communication participants with information regarding the time slots for which they have transmission authorizations, the resource manager transmits control messages to them as needed. Such control messages are advantageously made up of a list of software application identifiers. The interpretation of the control message is then able to take place according to the following scheme: the nth entry in the list assigns time slot n to the software application having the identifier specified at this nth list position.

### EXAMPLE

The control message contains a list having a total of 5 software application identifiers and appears as follows: R, K, U, E, K.

The interpretation of the message would then reveal the following allocation of time slots to software applications:
application R obtains a transmission authorization for time slot 1
application K obtains transmission authorizations for time slots 2 and 5
application U obtains a transmission authorization for time slot 3
application E obtains a transmission authorization for time slot 4.

However, many alternatives are also possible for the structure and the interpretation of the control message. Thus, the allocation according to communication participant is also possible, that is, the first n entries contain the serial numbers or number ranges of the time slots for the first software application, the next m entries accordingly for the second software application, etc.

In an additional advantageous form of the method according to the present invention, the resource manager may additionally modify the duration of the communication cycle and thereby modify the number of time slots in one cycle. In this manner, the communication system is able to be adjusted even more efficiently to changing communication requirements.

The allocation of time slots to software applications exists until the resource manager carries out a new allocation. Since with each new communication cycle the time slots are run through again from the beginning, these are cyclical transmission authorizations that endure until a subsequent control message indicates a new allocation of the time slots.

The resource manager has system-wide knowledge regarding the communication requirements of the individual software applications and is able to alter the allocation of time slots to the software applications at any time and in this way satisfy the requirements of individual software-applications that may change over time. Additional data-rate requirements may be met for instance by allocating additional time slots, decreased demand by removing individual time slots.

The resource manager is advantageously implemented with extended functionality. In its extended form, it identifies not only the participating software applications, but also the connections existing between them. It manages information regarding the connection quality QOS to be provided for every single connection. This may be specified by a fixed parameter set. In this connection, possible parameters are:
minimum data rate
maximum data rate
medium data rate
maximum permissible delay time of a message
minimum permissible delay time of a message
medium delay time of a message
maximum permissible variance of the delay time.

To provide the connections with a connection quality QOS that suffices for the respective parameters, the resource manager is now able to perform calculations for the optimal allocation of communication system resources to software applications and inform the software applications of the calculation results using the control messages described above.

Using the extended method described here, it is easily possible and in most cases advantageous to subdivide connections into classes and to allocate a separate QOS parameter set to each class. Then, one parameter set per connection no longer exists, but rather only one parameter set per class, which means that the implementation of the resource manager and in particular the calculations to be performed by this component are able to be simplified significantly.

The resource manager advantageously allocates time slots lying far toward the front of the communication cycle to high-priority connections, and time slots lying farther back to lower-priority connections. This is based on the property of the communication system according to which the total number of time slots may differ from cycle to cycle and depends on the extent to which time slots are actually used for transmitting data. Only the time slots that are actually used to transmit data have their full length in terms of time, whereas unused time slots are shortened in terms of time and thus the subsequent time slot is able to begin earlier. Consequently, if the available time slots are heavily burdened, only lower-priority connections are affected disadvantageously. Regarding this, the following example:

A communication cycle, that is, a time frame lasts 500 milliseconds. Unused time slots last exactly 2 milliseconds; time slots used for data transmissions last exactly 10 milliseconds. If all time slots remain unused, the cycle thus includes 250 time slots. In contrast, if all time slots for data transmissions are used, the cycle includes only 50 time slots. Each cycle thus includes at least 50 and at most 250 time slots. In case of doubt, the allocation of time slots 51 to 250 to software applications may thus mean that these software applications are not able to send data in spite of allocated time slots because the cycle ends before the time slot allocated to them is actually reached. The farther back a time slot lies, the greater the probability that it will no longer be reached before the end of the communication cycle. Thus, it is particularly advantageous to provide the back region of the time slots to those connections that place the fewest demands on the communication system with regard to their QOS parameters.

In addition to the previously mentioned prioritized allocation, an allocation that considers fairness may also be carried out. This may supersede the prioritized allocation at least in predefined time intervals, so that lower-priority connections are not completely excluded from a communication.

The resource manager has an evaluation and control device that may recognize the unused capacities in a time frame and may make these unused capacities available, in the form of additional time slots, to communication participants having an increased communication requirement.

ECUs connected to the communication system that do not implement the method of dynamic resource allocation by a central RM described here may be reliably integrated with the aid of an additional expansion of the method. To this end, the time slots provided by the communication system are subdivided into two groups. While for the one group of time slots the assignment to software applications is carried out at runtime by the resource manager as described above, the time slots of the other group are already permanently bound at the time of development to the software applications that do not implement the method described here. At runtime the resource manager has knowledge regarding which time slots it is able to dynamically allocate and which lie outside of its control because they were already statically allocated at the time of development.

In the following description, a FlexRay network 100 is assumed, to which three ECUs 200, 201, 202 are connected. ECU 200 has software applications 500 and 501; ECU 201 has software application 502; and ECU 202 has software applications 503 and 504 and also software application “resource manager” 600.

Software application 502 is an application that does not implement the method described here and that would like to use the FlexRay bus system only in the conventional manner, for handling the exchange of data.

The communication cycle of the FlexRay bus system is structured into a static and a dynamic segment. The method described here is to be applied to the dynamic segment. At this point, it should be pointed out that the static segment of the FlexRay communication cycle does not correspond to the previously explained properties of the communication system.

Now, at the time of development the dynamic segment of the FlexRay communication cycle is configured such that it lasts i milliseconds. An unused and thus shortened time slot lasts i/6 milliseconds, a used time slot lasts i/2 milliseconds.

At the time of development, any time slot, but in this example the first, is already permanently and exclusively allocated to software application 502. Resource manager 600 has the task of allocating the remaining 6-1 time slots to the software applications at runtime.

Once the system has been switched on, resource manager 600 sends a control message having the content: 500, 501, 501, 503, 504. ECUs 200 and 202 receive this control message and evaluate it. The following allocation of time slots to software applications results:
software application 500 sends in time slot 2,
software application 501 sends in time slot 3 and time slot 4,
software application 503 sends in time slot 5,
software application 504 sends in time slot 6.

In the now running operation, as shown in FIG. 2, the communication cycles (time frames) line up and the software applications may use or leave unused the periodically-recurring time slots that are allocated to them for the transmission of data. In FIG. 2, the length of the time slots used by the applications and the length of the unused time slots is recognizable. The first time frame is identified with N and the subsequent with N+1.

### Example 1

Assume that all software applications want to actually use the time slots allocated to them for a data transmission and do not leave any time slot unused. Then in the first time slot, software application 502 transmits first for duration i/2. Subsequently, software application 500 transmits in time slot 2, likewise for duration i/2. Now the communication cycle is finished, time slots 3 through 6 were not reached, and software applications 501, 503, and 504 may not transmit data in this cycle. Advantageously, resource manager 600 has carried out the assignment of time slots exactly so that exactly those messages were able to be transmitted whose transmission generated the largest benefit, while exactly those messages were not transmitted whose contribution to the overall benefit would have been smaller.

### Example 2

Assume that software applications 500 and 504 would like to use the time slots assigned to them for data transmission while all other software applications do not have a data transmission requirement and leave their time slots unused. Then none send in the first time slot. After i/6 milliseconds have elapsed, the time slot is terminated and time slot 2 begins. Software application 500 transmits in it, and the time slot ends after i/6+i/2=i/6+3i/6=4i/6 milliseconds. Subsequently, time slot 3 begins and, after 5i/6 milliseconds, ends, because it remains unused. Then time slot 4 begins, which likewise is not used. Now the communication cycle has come to an end and time slots 5 and 6 were not reached.

### Example 3

The resource manager recognizes that only software application 504 has a data transmission requirement and that it is very large, that is, very many messages from software application 504 must be transmitted suddenly. All other software applications have no data transmission requirement. The resource manager detects that the current (and previously specified) allocation of time slots to software applications is unfavorable and calculates a better allocation. It informs the software applications of the result of the calculation in the form of a control message. The control message reads: 504, 504, 504, 504, 504. With the exception of time slot 1, which stands outside of the control of the resource manager, all available time slots are assigned to the software application 504, which is able to handle its extensive data transmissions within these. All other applications incur no disadvantage through this reassignment since they do not have any data to transmit anyway and currently do not require any transmission capacity.

When the method according to the present invention is implemented, numbers of time slots per cycle that lie beneath the total communication participant number may be used. A shortening of the temporal duration of the communication cycle results therefrom and subsequently an increased rate of repetition of the communication cycle. In other words: this always reduces the transmission latency time for the communication participants that obtain static allocations and also for the selected dynamic communication participants. This effectively makes possible a clock-pulse increase for the communication participants.

The resource manager according to the present invention has an evaluation and control device that is able to detect unused capacities in a time frame either predictively or reactively and to provide these unused capacities to selected communication participants by assigning additional time slots.

1-11. (canceled)

12. A method for dynamic resource allocation in a communication system, comprising:
predefining a cyclical time frame of at least intermittently fixed temporal duration for access by communication participants of the communication system;
assigning time slots in the cyclical time frame to the communication participants;
reducing a duration of at least one assigned time slot which is unused by the corresponding communication participant, whereby at least one additional time slot is created for the cyclical time frame; and
dynamically assigning the at least one additional time slot to at least one of the communication participants, as a function of communication requirements of the communication participants.

13. The method as recited in claim 12, wherein the assigning of the time slots and the dynamically assigning of the at least one additional time slot are performed by a central resource manager.

14. The method as recited in claim 12, wherein for communication connections, quality parameters are exchanged, wherein the quality parameters include at least one of data rate, permissible delay time and permissible variance of the delay time, and wherein the quality parameters are evaluated by the central resource manager and taken into account in the assigning of the time slots and the dynamically assigning of the at least one additional time slot.

15. The method as recited in claim 14, further comprising:
providing priority assignments to the time slots in the time frame, wherein time slots situated at the start of the time frame are assigned to high-priority communication connections and temporally later time slots are assigned to lower-priority communication connections; and
dynamically changing the priority assignments depending on the communication requirements of the communication participants.

16. The method as recited in claim 14, further comprising:
transmitting control messages from the central resource manager to the communication participants, wherein the control messages contain the time slot assignments for the communication participants, wherein the time slot assignments are one of a) valid for one time frame each, or b) valid until a subsequent control message indicates a new time slot assignment.

17. The method as recited in claims 15, wherein the communication connections are divided into classes and a separate quality parameter set is assigned to each class.

18. The method as recited in claim 15, wherein the time slots are configured to be identifiable, and wherein exclusive transmission authorizations for a predefined number of identifiable time slots are assigned to the communication participants.

19. The method as recited in claim 15, wherein the reducing of the duration of at least one assigned time slot which is unused by the corresponding communication participant is triggered one of a) automatically as a function of at least one characteristic quantity of the communication system, or b) by the central resource manager.

20. The method as recited in claim 15, wherein the maximum number of time slots per time frame is fewer than the total number of communication participants.

21. The method according to claim 12, wherein the method is implemented using a FlexRay network, and wherein the dynamically assigning the at least one additional time slot is carried out only in the dynamic segment of the FlexRay time frame.

22. A system for dynamic resource allocation in a communication system, comprising:
providing a central resource manager configured to specify a cyclical time frame having a plurality of time slots for assignment to communication participants;
wherein the central resource manager has an evaluation and control device configured to detect, one of predictively or retrospectively, at least one assigned time slot which is unused by the corresponding communication participant, whereby at least one additional time slot is created for the cyclical time frame, and wherein the evaluation and control device dynamically assigns the at least one additional time slot to at least one selected communication participant.
